(19) United States
(12) Patent Application Publication
(10) Pub. No.: US 2015/0229503 A1
(43) Pub. Date: Aug. 13, 2015

(54) METHOD FOR GENERATING SIGNAL IN WIRELESS COMMUNICATION SYSTEM AND APPARATUS THEREFOR

(71) Applicant: Electronics & Telecommunications Research Institute, Daejeon (KR)

(72) Inventors: Kap Seok CHANG, Daejeon (KR); Seung Chan Bang, Daejeon (KR); Byung Jae Kwak, Daejeon (KR)

(73) Assignee: Electronics & Telecommunications Research Institute, Daejeon (KR)

(21) Appl. No.: 14/249,670

(22) Filed: Apr. 10, 2014

(30) Foreign Application Priority Data
Feb. 7, 2014 (KR) 10-2014-0014025
Mar. 28, 2014 (KR) 10-2014-0036429

(51) Int. Cl. H04L 27/26

(52) U.S. Cl. CPC H04L 27/2626; H04L 27/2615

(57) ABSTRACT

A method of generating a signal in a wireless communication system and an apparatus for the same are disclosed. A method of generating a transmission signal, performed in a transmission apparatus, comprises generating a first sequence having a convex/concave signal pattern; generating a second sequence meeting a predetermined auto and cross correlation property; and generating a transmission signal based on the first sequence and the second sequence. Thus, a transmission signal immune to a frequency offset can be generated.

### CLAIM FOR PRIORITY

This application claims priority to Korean Patent Applications No. 10-2014-0014025 filed on Feb. 7, 2014 and No. 10-2014-0036429 filed on Mar. 28, 2014 in the Korean Intellectual Property Office (KIPO), the entire contents of which are hereby incorporated by reference.

### BACKGROUND

1. Technical Field

Example embodiments of the present invention relate in general to a technology of designing signal, and more specifically, to a method of designing transmission signal in a wireless communication system and an apparatus for the same.

The present invention has been derived from a study based on a project for enhancing broadcasting communication standard technology, which is funded by a ministry of science, ICT and future planning and a Korea telecommunications technology association (project management number: 2013-PK10-24, project title: development of wireless communication technology standards of completely distributed object recognition based on IEEE 802.15.8).

2. Related Art

Generally, designing synchronization signals for acquisition of symbol synchronization (that is, acquisition of a start point of a symbol) is one of important technical issues which are handled in a wireless communication system. A terminal trying to access a specific wireless communication system should acquire symbol synchronization without information about an initial frequency offset (that is, a difference between carrier frequencies of transmission and reception ends). As the initial frequency offset is higher, a performance of estimating symbol synchronization becomes worse, and a latency required for an initial system access becomes longer. Here, the reason why the latency becomes longer is that it is impossible to access a wireless communication system during time consumed due to repeated failures for estimating symbol synchronization.

As algorithms for estimating symbol synchronization, there exist an aperiodic replica correlation (RC) based technique and a periodic differential correlation (DC) based technique. A wireless LAN (for example, IEEE 802.11n) uses the DC based technique for estimating symbol synchronization, and a cellular communication (for example, long-term evolution (LTE)) uses the RC based technique. The reason on the above is that the RC based technique may have lower symbol timing estimation error ratio (detection error rate, DER), that is, higher accuracy of symbol synchronization, than the DC based technique when there only exists a negligible initial frequency offset.

However, when there exists a high (non-negligible) frequency offset, the RC based technique may have a higher symbol timing estimation error ratio (DER) than the DC based technique, and have a high computational complexity in a symbol-timing estimator. Accordingly, if the RC based technique is used, a battery time of a terminal may be shortened as compared to that of the DC based technique.

Also, a Peak to Average Power Ratio (PAPR) in a wireless communication system based on Orthogonal Frequency Division Multiplexing (OFDM) may give a bad effect in a battery time of a transmitting apparatus due to non-linearity of an amplifier. Thus, a high PAPR may break all advantages of an OFDM based wireless communication system.

That is, as compared to the DC based technique, the RC based technique requires a high computational complexity in an estimator for acquiring symbol synchronization so that a battery life is shortened. Also, in a case in which PAPR is high, the RC based technique requires an expensive amplifier having a superb linearity so that it is not suitable to low cost mobile applications.

### SUMMARY

Accordingly, example embodiments of the present invention are provided to substantially obviate one or more problems due to limitations and disadvantages of the related art.

An example embodiment of the present invention provides a method of generating a transmission signal, which is immune to a frequency offset, resulting in a low fixed Peak to Average Power Ratio (PAPR) and a low complexity in a symbol-timing estimator.

In an example embodiment, a method of generating a transmission signal, performed in a transmission apparatus, may comprise generating a first sequence having a convex signal pattern; generating a second sequence meeting a predetermined auto and cross correlation property; and generating a transmission signal based on the first sequence and the second sequence.

Here, the convex signal pattern may have a vertically symmetrical shape within a predetermined time duration.

Here, the convex signal pattern may have a shape of a half-sine curve.

Here, the second sequence may be a binary sequence or a gold sequence.

Here, the method may further comprise allocating the transmission signal to a synchronization channel; and transmitting the synchronization channel.

In another example embodiment, a method of generating a transmission signal, performed in a transmission apparatus, may comprise generating a first sequence having a concave signal pattern; generating a second sequence meeting a predetermined auto and cross correlation property; and generating a transmission signal based on the first sequence and the second sequence.

Here, the concave signal pattern may have a vertically symmetrical shape within a predetermined time duration.

Here, the concave signal pattern may have a shape of a half-cosine curve.

Here, the second sequence may be a binary sequence or a gold sequence.

Here, the method may further comprise allocating the transmission signal to a synchronization channel; and transmitting the synchronization channel.

In other example embodiment, an apparatus for generating a transmission signal may comprise a sequence generating part generating a first sequence having a signal pattern configured to be immune to a frequency offset, and generating a second sequence which meets a predetermined auto and cross correlation property; and a signal generating part generating a transmission signal based on the first sequence and the second sequence

Here, the signal pattern may have a shape of a convex half-sine curve, and the convex half-sine curve may have a vertically symmetrical shape within a predetermined time duration.

Here, the signal pattern may have a shape of a concave half-cosine curve, and the concave half-cosine curve may have a vertically symmetrical shape within a predetermined time duration.

Here, the second sequence may be a binary sequence or a gold sequence.

Here, the apparatus may further comprise a transmission part allocating the transmission signal to a synchronization channel and transmitting the synchronization channel.

### BRIEF DESCRIPTION OF DRAWINGS

Example embodiments of the present invention will become more apparent by describing in detail example embodiments of the present invention with reference to the accompanying drawings, in which:

FIG. 1 is a flow chart to illustrate a method of generating a transmission signal according to an example embodiment of the present invention;

FIG. 2 is a flow chart to illustrate a method of generating a transmission signal according to another example embodiment of the present invention;

FIG. 3 is a block diagram to illustrate a signal generating apparatus according to an example embodiment of the present invention; and

FIG. 4 is a graph to illustrate properties of a transmission signal.

### DESCRIPTION OF EXAMPLE EMBODIMENTS

Example embodiments of the present invention are disclosed herein. However, specific structural and functional details disclosed herein are merely representative for purposes of describing example embodiments of the present invention, however, example embodiments of the present invention may be embodied in many alternate forms and should not be construed as limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” with another element, it can be directly connected or coupled with the other element or intervening elements may be present. In contrast, when an element is referred to as being “directly connected” or “directly coupled” with another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, embodiments of the present invention will be described in detail with reference to the appended drawings. In the following description, for easy understanding, like numbers refer to like elements throughout the description of the figures, and the same elements will not be described further.

In the entire specification, the term “network” used in this specification may include a mobile internet such as a Wireless Fidelity (WiFi), a Wireless Broadband Internet (WiBro), and a World Interoperability for Microwave Access (WiMax). Also, it may include 2G cellular network such as a Global System for Mobile communication (GSM) and a Code Division Multiple Access (CDMA), 3G cellular network such as a Wideband Code Division Multiple Access (WCDMA) and a cdma2000. Also, it may include 3.5G cellular network such as a High Speed Downlink Packet Access (HSDPA) and a High Speed Uplink Packet Access (HSUPA). Also, it may include 4G or beyond 4G cellular network such as a Long Term Evolution (LTE) and an LTE-Advanced.

In the entire specification, the term “terminal” used in this specification may be referred to as User Equipment (UE), a User Terminal (UT), a wireless terminal, an Access Terminal (AT), a Subscriber Unit (SU), a Subscriber Station (SS), a wireless device, a wireless communication device, a Wireless Transmit/Receive Unit (WTRU), a mobile node, a mobile, or other words. The terminal may be a cellular phone, a smart phone having a wireless communication function, a Personal Digital Assistant (PDA) having a wireless communication function, a wireless modem, a portable computer having a wireless communication function, a photographing device such as a digital camera having a wireless communication function, a gaming device having a wireless communication function, a music storing and playing appliance having a wireless communication function, an Internet home appliance capable of wireless Internet access and browsing, or also a portable unit or terminal having a combination of such functions. However, the terminal is not limited to the above-mentioned units.

In the entire specification, the term “base station” used in this specification means a fixed point that communicates with terminals, and may be referred to as another word, such as Node-B, eNode-B, a base transceiver system (BTS), an access point, etc. Also, the term “base station” means a controlling apparatus which controls at least one cell. In a real wireless communication system, a base station may be connected to and controls a plurality of cells physically, in this case, the base station may be regarded to comprise a plurality of logical base stations. That is, parameters configured to each cell are assigned by the corresponding base station.

Example embodiments according to the present invention which will be explained in the following description may be applied to a wireless communication system based on a single carrier (SC). However, an application domain of the example embodiment according to the present invention is not limited to the SC based system. That is, example embodiments according to the present invention may be applied to an OFDM based wireless communication system using a discrete Fourier transform (DFT) as well as the single carrier based wireless communication system.

Meanwhile, studies on a signal for symbol timing synchronization (STS), which is defined in an LTE specification, are being performed recently. The above-mentioned studies focus upon proposing effective estimation techniques for acquiring symbol timing synchronization (STS) which are usually performed in a receiving terminal. For example, an RC based technique optimized for calculating frequency-domain Zadoff-Chu (ZC) sequence elements has been proposed. Also, a time/frequency synchronization estimation technique, which combines the DC based technique and the RC based technique for achieving a low computational complexity in an estimator and a high STS accuracy, has been proposed. Also, an STS technique, based on the RC based technique and a central self-correlation technology using a time domain central-symmetric property (CSP) of frequency domain ZC sequence, has been proposed for achieving a low estimator complexity.

The above-described estimation techniques are techniques based on an STS signal defined in the LTE specification. Apart from the above techniques, a symbol timing synchronization signal itself, which can significantly enhance a performance of symbol timing estimation error ratio (detection error rate, DER) when a high frequency offset (FO) exists in using the RC based technique, has been proposed. However, a problem of such the technique is that it cannot reduce a computational complexity of a symbol-timing estimator as compared to a technique of symbol timing synchronization defined in the LTE specification.

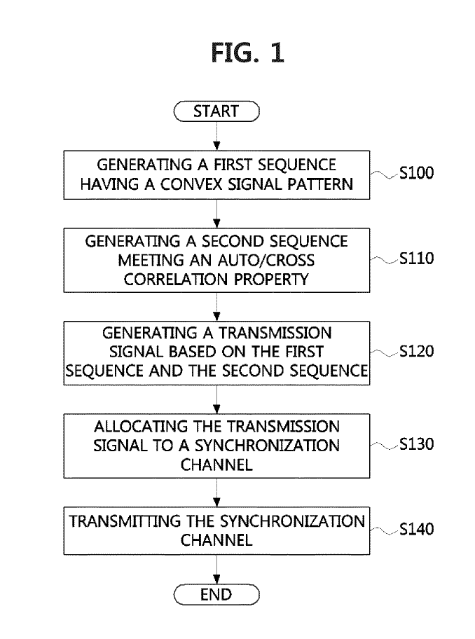

FIG. 1 is a flow chart to illustrate a method of generating a transmission signal according to an example embodiment of the present invention.

Referring to FIG. 1, a transmitting apparatus may generate a first sequence having a convex signal pattern (S100). Here, the transmitting apparatus may mean a base station or a terminal. The convex signal pattern may have a vertically symmetrical shape within a predetermined time duration (that is, a time duration corresponding to a total number of samples). That is, the first sequence may mean a signal having a central symmetric property (CSP). However, the convex signal pattern according to an example embodiment of the present invention is not limited to a rigid vertically symmetrical shape. Thus, the convex signal patterns having an approximate vertically symmetrical shape may be included in the scope of the present invention.

On the other hand, the convex signal pattern may have a half-sine curve shape, and be defined as the following equation 1.

$$F ( n , v ) = sin \frac{n π}{N} \\ for \\ 1 \leq n \leq N . \qquad [ Equation 1 ]$$

Here, F(n,v) means the first sequence (that is, the convex signal pattern), and v means an index of the first sequence, and N means the number of total samples which a symbol timing signal has, and n means a sample index of the symbol timing signal. On the other hand, although the first sequence which is not correlated to v is determined through the equation 1, the first sequence which is correlated to v may also be used for example embodiments of the present invention.

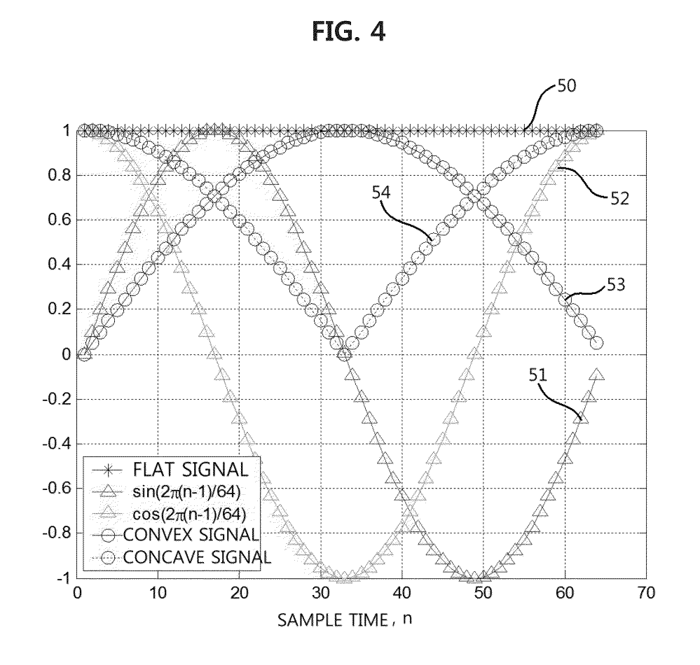

The above-mentioned shape of the first sequence is illustrated in FIG. 4. Hereinafter, a property of the first sequence will be explained by referring to FIG. 4.

FIG. 4 is a graph to illustrate properties of a transmission signal.

Referring to FIG. 4, a shape of the first sequence is identical to a convex signal 53. Here, the convex signal 53 may have a vertically symmetrical shape within a time duration (that is, a time duration corresponding to a total number of samples, N=64). If the first sequence defined in the above equation 1 is used, since a correlation output value of an STS estimator of a receiving terminal is higher than a threshold value, an STS estimation may be possible even when a high frequency offset exists.

Specifically, in a case that a frequency offset having a cycle for a total number N of samples exists (shown as 51, 52), if a flat signal 50 (that is, a sequence having a flat property) is used in a transmitting apparatus and a received signal is multiplied by a complex value having a real part cos(2π(n−1)/64) for n=1, 2, . . . , 64 (that is, a signal 52) and an imaginary part sin(2π(n−1)/64) for n=1, 2, . . . , 64 (that is, a signal 51), a correlation output value of an STS estimator of the receiving terminal may be near 0. Accordingly, the flat signal 50 may have a very low immunity to a frequency offset.

On the contrary, in a case that the first sequence defined in the above equation 1 (that is, a convex signal 53) is used, although an imaginary part of a correlation output value of a STS estimator may be near 0, a real part of the correlation output value may be higher than a threshold value due to a convex property of the signal. Accordingly, the receiving terminal may estimate a symbol timing synchronization using the high correlation output value.

Re-referring to FIG. 1, a transmitting apparatus may generate a second sequence meeting a predetermined auto and cross correlation property (S110). When the symbol timing synchronization is established by using the first sequence defined in the above equation 1, the immunity to a frequency offset can be enhanced as describe above. However, another factor of symbol timing synchronization performance, an auto correlation (or, a cross correlation) property may not always be enhanced. In this reason, a transmitting apparatus may use the second sequence meeting a predetermined auto and cross correlation property in order to solve the above-mentioned problem.

Here, the second sequence may mean a binary sequence or a complex sequence having an auto/cross correlation property which the first sequence defined in the above equation 1 does not have. In this case, a transmitting apparatus can use a binary sequence as the second sequence in order to reduce a computational complexity of an STS estimator approximately by three quarters.

Also, a transmitting apparatus may use a gold sequence defined in the following equation 2 as the second sequence.

$$C ( n , w ) = \{ \begin{matrix}W ( n ) = {G}_{1} ( n ) ⊕ {G}_{2} ( {[ n + w ]}_{{2}^{5} - 1} ) & for & 1 \leq n < \frac{N}{2} , \\ 0 & for & n = N / 2 , \\ C ( n , w ) = W ( n - \frac{N}{2} ) & for & \frac{N}{2} < n < N , \\ 0 & for & n = N .\end{matrix} \qquad [ Equation 2 ]$$

Here, C(n,w) means the second sequence, and w means an index of the second sequence. Also, N means the total number of samples of the STS, and n means an index of the STS for n=1, 2, . . . , 64. Also, ⊕ means an exclusive OR operation, and [.]_{M} means a modulo-M operation, and G₁(n) means a generator polynomial x⁵+1, and G₂(n) means a generator polynomial x⁵+x⁴+x+1.

Also, a transmitting apparatus may use a gold sequence defined in the following equation 3 as the second sequence.

$$C ( n , w ) = \{ \begin{matrix}W ( n ) = {G}_{1} ( n ) ⊕ {G}_{2} ( {[ n + w ]}_{{2}^{5} - 1} ) & for & 1 \leq n < \frac{N}{2} , \\ 0 & for & n = N / 2 , \\ C ( n , w ) = \pm W ( N - n ) & for & \frac{N}{2} < n < N , \\ 0 & for & n = N .\end{matrix} \qquad [ Equation 3 ]$$

The reason for employing C(n,w)=±W(N−n) in equation 3 is for using central symmetric property of the half-sine curve shape shown in equation 1.

A transmitting apparatus may generate a transmission signal based on the first sequence and the second sequence (S120). That is, the transmitting apparatus may generate the transmission signal by using the following equation 3.

S(n)=aC(n,w)F(n,v), n=1,2, . . . ,N. [Equation 4]

Here, S(n) means a transmission signal, and a means a coefficient controlling an average transmission power, and C(n,w) means the second sequence defined in the above equations 2 and 3, and F(n,v) means the first sequence defined in the above equation 1. Also, N means the total number of samples of the STS, and n means a sample index of the STS.

In addition, the transmitting apparatus may allocate the transmission signal generated through the above-described procedure to a synchronization channel (S130), and transmit the synchronization channel to which the transmission signal is allocated (S140).

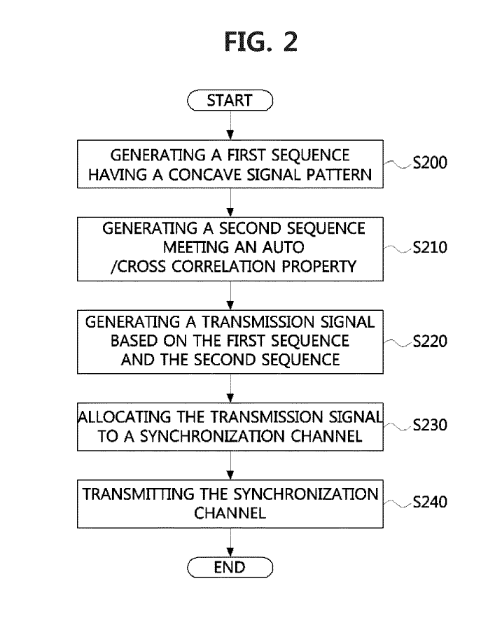

FIG. 2 is a flow chart to illustrate a method of generating a transmission signal according to another example embodiment of the present invention.

Referring to FIG. 2, a transmitting apparatus may generate a first sequence having a concave signal pattern (S200). Here, the transmitting apparatus may mean a base station or a terminal. The concave signal pattern may have a vertically symmetrical shape in a predetermined time duration (that is, a time duration corresponding to a total number of samples). That is, the first sequence may mean a signal having a central symmetric property. However, the concave signal pattern according to an example embodiment of the present invention is not limited to a rigid vertically symmetrical shape. Thus, the concave signal patterns having an approximate vertically symmetrical shape may be included in the scope of the present invention.

On the other hand, the concave signal pattern may have a half-cosine curve shape, and be defined as the following equation 4.

$$F ( n , v ) = \vert cos \frac{n π}{Nd} \vert \\ for \\ 1 \leq n \leq N . \qquad [ Equation 5 ]$$

Here, F(n,v) means the first sequence (that is, the concave signal pattern), and v means an index of the first sequence, and N means the number of total samples which a symbol timing signal has, and n means a sample index of the symbol timing signal. On the other hand, although the first sequence which is not correlated to v is determined through the equation 4, the first sequence which is correlated to v may also be used for example embodiments of the present invention.

The above-mentioned shape of the first sequence is illustrated in FIG. 4. Hereinafter, properties of the first sequence will be explained by referring to FIG. 4.

Referring to FIG. 4, a shape of the first sequence is identical to a concave signal 54. Here, the concave signal 54 may have a vertically symmetrical shape within a predetermined time duration (that is, a time duration corresponding to a total number of samples). If the first sequence defined in the above equation 5 is used, since a correlation output value of an STS estimator of a receiving terminal is higher than a threshold value, an STS estimation may be possible even when a high frequency offset exists.

Specifically, in a case that a frequency offset having a cycle for a total number N of samples exists (shown as 51, 52), if a flat signal 50 (that is, a sequence having a flat property) is used in a transmitting apparatus and a received signal is multiplied by a complex value having a real part cos(2π(n−1)/64) for n=1, 2, . . . , 64 (that is, a signal 52) and an imaginary part sin(2π(n−1)/64) for n=1, 2, . . . , 64 (that is, a signal 51), a correlation output value of an STS estimator of the receiving terminal may be near 0. Accordingly, the flat signal 50 may have a very low immunity to a frequency offset.

On the contrary, in a case that the first sequence defined in the above equation 5 (that is, a concave signal 54) is used, although an imaginary part of a correlation output value of a STS estimator may be near 0, a real part of the correlation output value may be higher than a threshold value due to a concave property of the signal. Accordingly, the receiving terminal may estimate a symbol timing synchronization using the high correlation output value.

Re-referring to FIG. 2, a transmitting apparatus may generate a second sequence meeting a predetermined auto and cross correlation property (S210). When the symbol timing synchronization is established by using the first sequence defined in the above equation 5, the immunity to a frequency offset can be enhanced as describe above. However, another factor of symbol timing synchronization performance, an auto correlation (or, a cross correlation) property may not always be enhanced. In this reason, a transmitting apparatus may use the second sequence meeting a predetermined auto and cross correlation property in order to solve the above-mentioned problem.

Here, the second sequence may mean a binary sequence or a complex sequence having an auto/cross correlation property which the first sequence defined in the above equation 5 does not have. In this case, a transmitting apparatus can use a binary sequence as the second sequence in order to reduce a computational complexity of a STS estimator approximately by three quarters. Also, a transmitting apparatus may use a gold sequence defined in the following equations 2 and 3 as the second sequence.

The transmitting apparatus may generate a transmission signal based on the first sequence and the second sequence (S220). That is, the transmitting apparatus may use the above equation 4 to generate the transmission signal (that is, S(n)).

In addition, the transmitting apparatus may allocate the transmission signal generated through the above-described procedure to a synchronization channel (S230), and transmit the synchronization to which the transmission signal is allocated (S240).

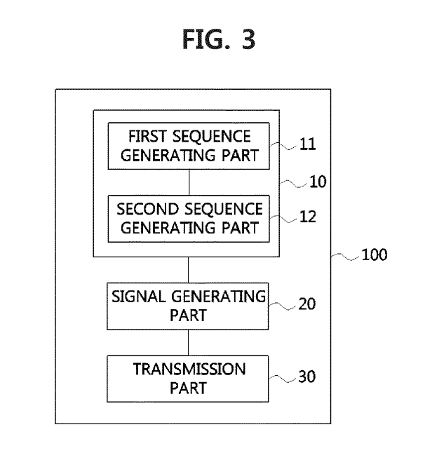

FIG. 3 is a block diagram to illustrate a signal generating apparatus according to an example embodiment of the present invention.

Referring to FIG. 3, the signal generating apparatus 100 may include a sequence generating part 10, a signal generating part 20, and a transmission part 30. The sequence generating part 10 may comprise a first sequence generating part 11 and a second sequence generating part 12. Here, the signal generating apparatus 100 may mean a base station or a terminal itself, or may mean an apparatus included in a base station or a terminal.

The first sequence generating part 11 may generate a first sequence having a signal pattern configured to be immune to a frequency offset. For example, the first sequence generating part 11 may generate a signal having a shape of convex half-sine curve (that is, F(n,v)) based on the above equation 1, and the convex half-sine curve may have a vertically symmetrical shape within a predetermined time duration (that is, a time duration corresponding to a total number of samples).

Alternatively, the first sequence generating part 11 may generate a signal having a shape of a concave half-cosine curve (that is, F(n,v)) based on the above equation 5, and the concave half-cosine curve may have a vertically symmetrical shape within an arbitrary time duration (that is, a time duration corresponding to a total number of samples).

The second sequence generating part 12 may generate a second sequence meeting a predetermined auto and cross correlation property. For example, a binary sequence or a complex sequence may be used as the second sequence. Also, the second sequence generating part 12 may generate a gold sequence (that is, C(n,w)) based on the above equations 2 and 3, and use the gold sequence as the second sequence.

The signal generating part 20 may generate a transmission signal based on the first sequence generated through the first sequence generating part 11 and the second sequence generated through the second sequence generating part 12. For example, the signal generating part 20 may generate the transmission signal (that is, S(n)) based on the above equation 4.

The transmission part 30 may allocate the generated transmission signal generated through the signal generating part 20 to a synchronization channel, and transmit the synchronization signal to which the transmission signal is allocated.

According to the present invention, a transmission signal immune to a frequency offset can be designed. Therefore, a PAPR may be decreased in a transmitting end, and symbol synchronization may be acquired accurately in a receiving end. Also, a computational complexity of an STS estimator in the receiving end may be reduced approximately by three quarters.

While the example embodiments of the present invention and their advantages have been described in detail, it should be understood that various changes, substitutions and alterations may be made herein without departing from the scope of the invention.

What is claimed is:

1. A method of generating a transmission signal, performed in a transmission apparatus, the method comprising:
generating a first sequence having a convex signal pattern;
generating a second sequence meeting a predetermined auto and cross correlation property; and
generating a transmission signal based on the first sequence and the second sequence.

2. The method of claim 1, wherein the convex signal pattern has a vertically symmetrical shape within a predetermined time duration.

3. The method of claim 1, wherein the convex signal pattern has a shape of a half-sine curve.

4. The method of claim 1, wherein the second sequence is a binary sequence.

5. The method of claim 1, wherein the second sequence is a gold sequence.

6. The method of claim 1, further comprising:
allocating the transmission signal to a synchronization channel; and
transmitting the synchronization channel.

7. A method of generating a transmission signal, performed in a transmission apparatus, the method comprising:
generating a first sequence having a concave signal pattern;
generating a second sequence meeting a predetermined auto and cross correlation property; and
generating a transmission signal based on the first sequence and the second sequence.

8. The method of claim 7, wherein the concave signal pattern has a vertically symmetrical shape within a predetermined time duration

9. The method of claim 7, wherein the concave signal pattern has a shape of a half-cosine curve.

10. The method of claim 7, wherein the second sequence is a binary sequence.

11. The method of claim 7, wherein the second sequence is a gold sequence.

12. The method of claim 7, further comprising:
allocating the transmission signal to a synchronization channel; and
transmitting the synchronization channel.

13. An apparatus for generating a transmission signal, comprising:
a sequence generation part generating a first sequence having a signal pattern configured to be immune to a frequency offset, and generating a second sequence which meets a predetermined auto and cross correlation property; and
a signal generation part generating a transmission signal based on the first sequence and the second sequence.

14. The apparatus of claim 13, wherein the signal pattern has a shape of a convex half-sine curve.

15. The apparatus of claim 14, wherein the convex half-sine curve has a vertically symmetrical shape within a predetermined time duration.

16. The apparatus of claim 13, wherein the signal pattern has a shape of a concave half-cosine curve.

17. The apparatus of claim 16, wherein the concave half-cosine curve has a vertically symmetrical shape within a predetermined time duration.

18. The apparatus of claim 13, wherein the second sequence is a binary sequence.

19. The apparatus of claim 13, wherein the second sequence is a gold sequence.

20. The apparatus of claim 13, further comprising a transmission part allocating the transmission signal to a synchronization channel and transmitting the synchronization channel.
